(19) United States
(12) Patent Application Publication
(10) Pub. No.: US 2005/0144340 A1
(43) Pub. Date: Jun. 30, 2005

(54) Remote control receiving apparatus

(75) Inventor: Shogo Sakai, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/019,627

(22) Filed: Dec. 23, 2004

(30) Foreign Application Priority Data
Dec. 25, 2003 (JP) P.2003-430860

(51) Int. Cl. G06F 3/00

(52) U.S. Cl. 710/48

(57) ABSTRACT

An interrupt recognition unit recognizes that an interrupt occurs at the time of detecting a valid level change of a signal sent from a remote controller, and a port determination unit directly determines a signal level of a port at the time of recognizing that the interrupt occurs by the interrupt recognition unit. An interrupt processing unit accepts the interrupt to perform normal receiving processing when the signal level directly determined by the port determination unit is valid. On the other hand, the interrupt processing unit performs processing of ignoring the interrupt when the signal level is invalid.

### BACKGROUND OF THE INVENTION

1. Field of the Invention

The present invention relates to a remote control receiving apparatus constructed so that a signal sent from a remote control (remote controller) is inputted to perform predetermined processing and a control signal corresponding to the sent signal is outputted.

2. Description of the Related Art

Conventionally, there are provided a remote controller for sending an infrared signal of digital information indicating the contents of operation and a remote control receiving apparatus which is provided in the side of an equipment body and receives the infrared signal from the remote controller in order to remotely operate on-off of a power source of the equipment body, selection of a channel, volume adjustment, etc. in a television, video equipment, audio equipment, etc. and also on-off of a power source of the equipment body, temperature adjustment, etc. similarly in an air conditioner. The remote controller sends digital information consisting of logic “1” and “0” by an infrared signal in order to control the equipment body by remote operation. In the remote control receiving apparatus, the infrared signal of the digital information from the remote controller is received by a remote control light receiving part and its digital information is decoded by a processing part and a control signal is supplied to a main circuit of the equipment body and a power source of the body is turned on or off or other operations are performed.

By the way, in such a conventional remote control receiving apparatus, for example, a determination of a bit of digital information is made by a width ranging from the trailing edge of a signal of digital information indicating the contents of operation from the remote controller to the next trailing edge, for example, a period 3T (T is a period of a reference clock signal) as shown in FIG. 4, but there are cases where the leading edge (invalid level change) is incorrectly recognized as the trailing edge (valid level change) to generate an interrupt due to processing precision of the processing part or characteristics of the remote control light receiving part or noise. As a result of this, the remote control receiving apparatus supplies an incorrect control signal to the main circuit etc. of the equipment body and an operation different from the operation desired by a user is performed in the equipment body.

Thus, the conventional art of JP-A-6-233355 includes an inversion unit for receiving and inverting a signal sent from an infrared remote controller, a first pulse generation unit for receiving an output of the inversion unit and outputting a pulse of a predetermined pulse width, an identification unit for identifying the sent signal and mixed noise based on the output of the first pulse generation unit and the output of the inversion unit and producing an output to the mixed noise and a second pulse generation unit for outputting a pulse of a predetermined pulse width based on the output of the identification unit, and is configured so as to prevent a malfunction by stopping an input to an equipment body for a certain time when the mixed noise is inputted based on the output from the second pulse generation unit. However, in the configuration of this conventional art, a circuit for noise detection is required and a circuit configuration tends to become complicated.

The conventional art of JP-A-7-128461 includes an interrupt unit for detecting a change from a first state to a second state of a pulse signal inputted through one input port and generating an interrupt, a storage unit for storing the fact that a state of the pulse signal is the second state when an interrupt is generated by the interrupt unit, a wait unit for waiting a change from the second state to the first state of the pulse signal when the fact that a state of the pulse signal is the second state is stored by the storage unit, a determination unit for determining whether or not a state of the pulse signal inputted to the input port is the second state, and an alteration unit for altering a wait for a change in the pulse signal by the wait unit so as to wait a change from the first state to the second state when the determination unit determines that the state is not the second state. However, in this conventional art, measures against a situation in which due to processing precision etc. of a CRTECU acting as a processing part, for example, the leading edge is incorrectly recognized as the trailing edge to generate an interrupt are not taken.

In the conventional art of JP-A-8-70490, in an infrared wireless remote controller, a control part includes a read part, a sampling part counter of a high level signal and a low level signal of a signal waveform at an interval shorter than pulse basic time at the back stage and a noise determination part for making a noise determination by a sampling result, and the noise determination part is also used as a noise determination part in which in a front stage of a reader part, a high level signal of the reader part is stored in the sampling part counter as a reader part determination criterion and when a portion prior to this high level signal is a continuous portion more than or equal to the low level signal of the reader part, it can be determined that it is the reader part. However, in this conventional art, it is necessary to check the high level and the low level every certain time always and also a high-speed clock signal is required in order to increase precision of the counter and it is necessary to trace the signals always, so that processing tends to become complicated.

### SUMMARY OF THE INVENTION

The invention is implemented to solve the problems as described above, and an object of the invention is to provide a remote control receiving apparatus in which a situation in which an invalid level change is incorrectly recognized as a valid level change to generate an interrupt due to processing precision, characteristics or noise is eliminated and also the need for a circuit for noise detection is eliminated and processing for prevention of a malfunction can also be simplified.

In order to achieve the object, according to a first aspect of the invention, there is provided a remote control receiving apparatus constructed so that a signal sent from a remote controller is inputted to perform predetermined processing and a control signal corresponding to the sent signal is outputted, including a processing part having an interrupt recognition unit for recognizing that an interrupt occurs at the time of detecting a valid level change of the sent signal from the remote controller, a port determination unit for directly determining a signal level of a port at the time of recognizing that the interrupt occurs by the interrupt recognition unit, and an interrupt processing unit for accepting the interrupt to perform normal receiving processing when the signal level directly determined by the port determination unit is valid and also performing processing of ignoring the interrupt when the signal level is invalid.

In this configuration, the interrupt recognition unit recognizes that an interrupt occurs at the time of detecting a valid level change of the sent signal from the remote controller, and the port determination unit directly determines a signal level of a port at the time of recognizing that this interrupt occurs. The interrupt processing unit accepts the interrupt to perform normal receiving processing when the signal level directly determined by the port determination unit is valid. On the other hand, the interrupt processing unit performs processing of ignoring the interrupt when the signal level is invalid.

According to this configuration, even when a level change of an invalid signal is detected as a valid level change and it is recognized that an interrupt occurs, the interrupt is ignored in the case that a signal level of a port indicates invalidity. For example, in spite of the leading edge (invalid level change), even in the case of detecting that the edge is the trailing edge (valid level change) and recognizing that an interrupt occurs, the interrupt is ignored when a signal of a port is at a H level (invalid level). Therefore, a situation in which an invalid level change is incorrectly recognized as a valid level change to generate an interrupt due to processing precision, characteristics or noise is eliminated and as a result of this, failure in receiving or incorrect determination of the signal from the remote controller can be prevented and also the need for a circuit for noise detection is eliminated and processing for prevention of a malfunction can also be simplified.

According to a second aspect of the invention, there is provided a remote control receiving apparatus constructed so that a signal sent from a remote controller is inputted to perform predetermined processing and a control signal corresponding to the sent signal is outputted, including a processing part in which at the time of recognizing that an interrupt occurs by a valid level change of the sent signal from the remote controller, a signal level of a port is directly determined and when the signal level is valid, the interrupt is accepted to perform normal receiving processing and when the signal level is invalid, processing of ignoring the interrupt is performed.

In this configuration, a processing part directly determines a signal level of a port at the time of recognizing that an interrupt occurs by a valid level change of the sent signal from the remote controller, and accepts the interrupt to perform normal receiving processing when the signal level is valid, and performs processing of ignoring the interrupt when the signal level is invalid.

According to this configuration, even when a level change of an invalid signal is detected as a valid level change and it is recognized that an interrupt occurs, the interrupt is ignored in the case that a signal level of a port indicates invalidity. Therefore, a situation in which an invalid level change is incorrectly recognized as a valid level change to generate an interrupt due to processing precision, characteristics or noise is eliminated and as a result of this, failure in receiving or incorrect determination of the signal from the remote controller can be prevented and also the need for a circuit for noise detection is eliminated and processing for prevention of a malfunction can also be simplified.

According to a third aspect of the invention, the processing part according to the second aspect of the invention has a interrupt recognition unit for recognizing that an interrupt occurs at the time of detecting a valid level change of the sent signal from the remote controller, a port determination unit for directly determining a signal level of a port at the time of recognizing that the interrupt occurs by the interrupt recognition unit, and an interrupt processing unit for accepting the interrupt to perform normal receiving processing when the signal level directly determined by the port determination unit is valid and also performing processing of ignoring the interrupt when the signal level is invalid, so that even when a level change of an invalid signal is detected as a valid level change and it is recognized that an interrupt occurs, the interrupt can be ignored in the case that a signal level of a port indicates invalidity. Therefore, contribution can be made to elimination of a situation in which an invalid level change is incorrectly recognized as a valid level change to generate an interrupt due to processing precision, characteristics or noise.

According to the invention as described above, even when a level change of an invalid signal is detected as a valid level change and it is recognized that an interrupt occurs, the interrupt is ignored in the case that a signal level of a port indicates invalidity, so that a situation in which an invalid level change is incorrectly recognized as a valid level change to generate an interrupt due to processing precision, characteristics or noise is eliminated and as a result of this, failure in receiving or incorrect determination of a signal from a remote controller can be prevented and also the need for a circuit for noise detection is eliminated and processing for prevention of a malfunction can also be simplified.

### BRIEF DESCRIPTION OF THE DRAWINGS

These and other objects and advantages of this invention will become more fully apparent from the following detailed description taken with the accompanying drawings in which:

FIG. 1 is a block diagram showing a configuration of a remote control receiving apparatus according to one embodiment of the invention;

FIG. 2 is a waveform chart of a digital signal in which an infrared sent signal from a remote controller is received and is converted into an electrical signal and is outputted in a remote control light receiving part of the embodiment;

FIG. 3 is a flowchart describing an action of a processing part in the embodiment; and

FIG. 4 is a waveform chart of a digital signal in which an infrared sent signal from a remote controller is received and is converted into an electrical signal and is outputted in a remote control light receiving part of a conventional remote control receiving apparatus.

### DETAILED DESCRIPTION OF THE PREFERRED EMBODIMENTS

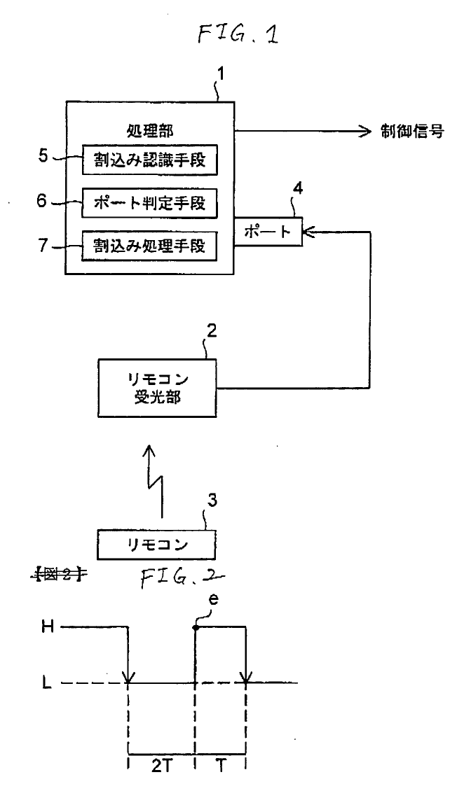

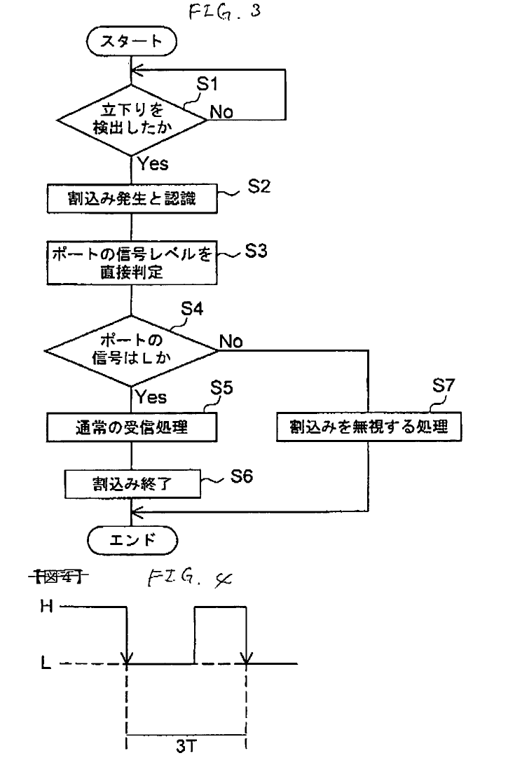

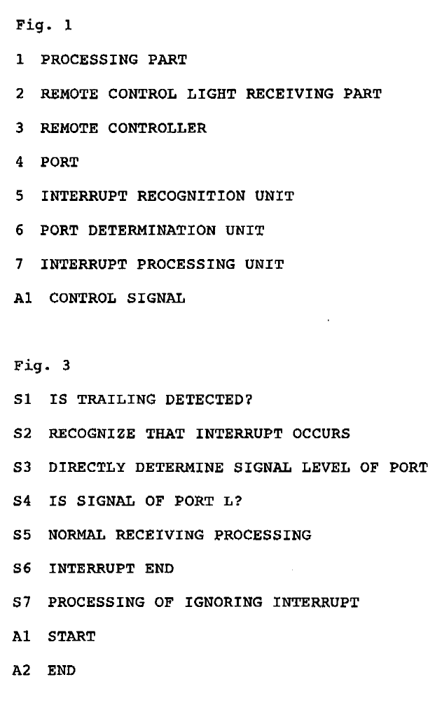

An embodiment of the invention will be described below with reference to the accompanying drawings. FIG. 1 is a block diagram showing a configuration of a remote control receiving apparatus according to one embodiment of the invention. This remote control receiving apparatus includes a remote control light receiving part 2 for receiving a sent signal (infrared signal) of digital information indicating the contents of operation from a remote controller 3 and converting the signal into an electrical signal and outputting the signal as a digital signal, and a processing part 1 for inputting a digital signal outputted from this remote control light receiving part 2 and performing predetermined processing and outputting a control signal corresponding to the sent signal (contents of operation) and supplying the signal to a main circuit (not shown) etc. Incidentally, the remote control light receiving part 2, the processing part 1 and the main circuit (not shown) are provided inside electrical equipment. The electrical equipment refers to, for example, a television, video equipment, audio equipment, an air conditioner and other equipment s for performing control by remote operation.

The processing part 1 has an interrupt recognition unit 5 which is implemented by a microcomputer etc. and recognizes that an interrupt occurs at the time of detecting a valid level change of the sent signal from the remote controller 3 as a component characterizing the present embodiment, a port determination unit 6 for directly determining a signal level of a port 4 at the time of recognizing that the interrupt occurs by the interrupt recognition unit 5, and an interrupt processing unit 7 for accepting the interrupt to perform normal receiving processing when the signal level directly determined by the port determination unit 6 is valid and also performing processing of ignoring the interrupt when the signal level is invalid.

FIG. 2 is a waveform chart of a digital signal in which the infrared sent signal from the remote controller 3 is received and is converted into an electrical signal and is outputted in the remote control light receiving part 2 of the embodiment. In FIG. 2, a point e indicates that the signal level of the port 4 is directly determined by the port determination unit 6. For example, even in the case of determining that the edge of the point e is the trailing edge though it is originally the leading edge and recognizing that an interrupt occurs, the signal of the port 4 is at a H level at the point e, so that its interrupt is ignored. As a result of this, a situation in which an invalid level change is incorrectly recognized as a valid level change to generate an interrupt due to processing precision of the processing part 1, characteristics of the remote control light receiving part 2 or noise is eliminated and therefore, failure in receiving or incorrect determination of the signal from the remote controller 3 can be prevented and also the need for a circuit for noise detection is eliminated and processing for prevention of a malfunction can also be simplified.

FIG. 3 is a flowchart describing an action of the processing part 1 in the embodiment. When a user depresses a power source key of the remote controller 3 in order to turn on, for example, a body power source (main power source) of electrical equipment (not shown), digital information indicating the contents of operation (power-on) is outputted from the remote controller 3 as an infrared sent signal. The remote control light receiving part 2 which has received the infrared sent signal converts the infrared sent signal into an electrical signal and outputs the signal to the processing part 1 as a digital signal.

The processing part 1 inputs the digital signal from the remote control light receiving part 2 through the port 4. In the processing part 1, the interrupt recognition unit 5 detects a trailing, which is a valid level change, of the digital signal (step S1) and recognizes that an interrupt occurs at this time (step S2). Also, at this time, the port determination unit 6 directly determines a signal level of the port 4 at the time of recognizing that the interrupt occurs (step S3).

That is, the port determination unit 6 determines whether or not the signal of the port 4 is at a L level indicating a valid level (step S4), and when the signal of the port 4 is at the L level, the interrupt processing unit 7 performs normal receiving processing (step S5). In the case of this example, processing of turning on a power source of a body of electrical equipment is performed. Thereafter, the interrupt of the present processing is ended (step S6).

On the other hand, when the port determination unit 6 determines that the signal of the port 4 is at a H level indicating an invalid level, processing of ignoring the occurrence of interrupt recognized by the interrupt recognition unit 5 is performed (step S7). Therefore, in this case, the interrupt is ignored, so that the processing part 1 does not output a control signal with respect to the leading edge.

By such processing, a situation in which the leading edge of the digital signal inputted to the processing part 1 is incorrectly recognized as the trailing edge to generate an interrupt due to processing precision of the processing part 1, characteristics of the remote control light receiving part 2 or noise is eliminated and therefore, failure in receiving or incorrect determination of the signal from the remote controller 3 can be prevented and also the need for a circuit for noise detection is eliminated and processing for prevention of a malfunction can also be simplified.

In the case of checking the H level and the L level of the signal of the port 4 every certain time always, it is necessary to check the signal of the port 4 using a high-speed clock signal, but as described in the embodiment, an interrupt is used and the signal of the port 4 immediately after the interrupt recognized is checked, so that a very high-speed clock frequency is not required.

Incidentally, in the embodiment, the description in which in the case that the processing part 1 operates by the trailing edge of an input signal, the trailing edge of the digital signal inputted to the processing part 1 is used as a valid signal and the leading edge is used as an invalid signal has been made, but the embodiment is not limited to this and in the case that the processing part 1 operates by the leading edge of an input signal, the leading edge of the digital signal inputted to the processing part 1 may be used as a valid signal and the trailing edge may be used as an invalid signal.

1. A remote control receiving apparatus constructed so that a signal sent from a remote controller is inputted to perform predetermined processing and a control signal corresponding to the sent signal is outputted, the remote control receiving apparatus comprising:
a remote control light receiving part for receiving the signal sent from the remote controller; and
a processing part including:
an interrupt recognition unit for recognizing that an interrupt occurs at the time of detecting a valid level change of the signal received the remote control light receiving part;
a port determination unit for directly determining a signal level of a port at the time of recognizing that the interrupt occurs by the interrupt recognition unit; and
an interrupt processing unit for accepting the interrupt to perform normal receiving processing when the signal level directly determined by the port determination unit is valid and also performing processing of ignoring the interrupt when the signal level is invalid.

2. A remote control receiving apparatus constructed so that a signal sent from a remote controller is inputted to perform predetermined processing and a control signal corresponding to the sent signal is outputted, the remote control receiving apparatus comprising:
a remote control light receiving part for receiving the signal sent from the remote controller; and
a processing part in which at the time of recognizing that an interrupt occurs by a valid level change of the signal received the remote control light receiving part, a signal level of a port is directly determined and when the signal level is valid, the interrupt is accepted to perform normal receiving processing and when the signal level is invalid, processing of ignoring the interrupt is performed.

3. A remote control receiving apparatus according to claim 2, wherein
the processing part includes:
an interrupt recognition unit for recognizing that an interrupt occurs at the time of detecting a valid level change of the signal received the remote control light receiving part;
a port determination unit for directly determining a signal level of a port at the time of recognizing that the interrupt occurs by the interrupt recognition unit; and
an interrupt processing unit for accepting the interrupt to perform normal receiving processing when the signal level directly determined by the port determination unit is valid and also performing processing of ignoring the interrupt when the signal level is invalid.
